(19) United States
(12) Patent Application Publication
(10) Pub. No.: US 2010/0106447 A1
(43) Pub. Date: Apr. 29, 2010

(54) DEFECT ANALYZING APPARATUS AND DEFECT ANALYZING METHOD

(76) Inventor: Yasuyuki YAMADA, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/560,273

(22) Filed: Sep. 15, 2009

(30) Foreign Application Priority Data
Oct. 28, 2008 (JP) 2008-276930

(51) Int. Cl. G01N 21/00

(52) U.S. Cl. 702/117; 702/83

(57) ABSTRACT

A defect analyzing apparatus capable of acquiring standard data easily and a defect analyzing method are provided. The defect analyzing apparatus includes: a storage section storing data including information of a processing pattern corresponding to a predetermined processing to a semiconductor wafer; a first extracting section extracting a first frequency distribution of each of characteristics in a plurality of sample places in a semiconductor chip; a second extracting section extracting a second frequency distribution of each of the characteristics in a plurality of defect places in the semiconductor chip; and a detecting section detecting discrepancies between the first and second frequencies.

### CROSS-REFERENCE TO RELATED APPLICATIONS

This application is based upon and claims the benefit of priority from the prior Japanese Patent Application No. 2008-276930, filed on Oct. 28, 2008; the entire contents of which are incorporated herein by reference.

### BACKGROUND OF THE INVENTION

1. Field of the Invention

The present invention relates to a defect analyzing apparatus analyzing a defect of a semiconductor device and a defect analyzing method.

2. Description of the Related Art

Semiconductor devices such as an IC and an LSI are fabricated by process steps of film-forming and the like on a semiconductor wafer. There is disclosed a technique to specify a cause of defect occurrence in order to improve a yield of the semiconductor device at that time (see, for example, JP-A 2006-351723 (KOKAI)).

Meanwhile, when specifying a cause of occurrence of a bad product, inspection data is often compared with standard data. It can be considered that the inspection data which substantially differs from the standard data corresponds to occurrence of a defect. Generally, in many cases, inspection data at a time of a low occurrence frequency is collected and used as standard data.

However, there is a case that acquisition of standard data is difficult. The above is a situation that, for example, systematic defects make up most of the defects, such as at a start up of a new process. At this time, it is difficult to judge what should be used as standard data.

### BRIEF SUMMARY OF THE INVENTION

An object of the present invention is to provide a defect analyzing apparatus capable of acquiring standard data easily and a defect analyzing method.

A defect analyzing apparatus according to an aspect of the present invention includes: a storage section storing data including information of a processing pattern corresponding to a predetermined processing to a semiconductor wafer; a first extracting section extracting a first frequency distribution of each of characteristics in a plurality of sample places in a semiconductor chip; a second extracting section extracting a second frequency distribution of each of the characteristics in a plurality of defect places in the semiconductor chip; and a detecting section detecting discrepancies between the first and second frequencies.

A defect analyzing method according to an aspect of the present invention includes: extracting a first frequency distribution of each of characteristics in a plurality of sample places in a semiconductor chip; extracting a second frequency distribution of each of the characteristics in a plurality of defect places in the semiconductor chip; and detecting discrepancies between the first and second frequencies.

### BRIEF DESCRIPTION OF THE DRAWINGS

FIG. 1 is a block diagram showing an inspection system 100 according to an embodiment of the present invention.

FIG. 2 is a diagram showing a correspondence between a semiconductor wafer W and a defect place Pd.

FIG. 3 is a diagram showing a correspondence between a semiconductor chip C and a defect place Pd.

FIG. 4 is a graph showing an example of a frequency distribution of a characteristic derived by a distribution deriving section 132B.

FIG. 5 is a diagram showing an example of a relation between a semiconductor chip C and a sample place Ps.

FIG. 6 is a diagram showing an example of a relation between a unit area Au and a sample place Ps on a semiconductor chip C.

FIG. 7 is a graph for explaining extraction of a characteristic in a discrepancy detecting section 134B.

FIG. 8 is a flowchart showing an example of operational procedures of the inspection system 100.

### DETAILED DESCRIPTION OF THE INVENTION

Hereinafter, an embodiment of the present invention will be described in detail with reference to the drawings.

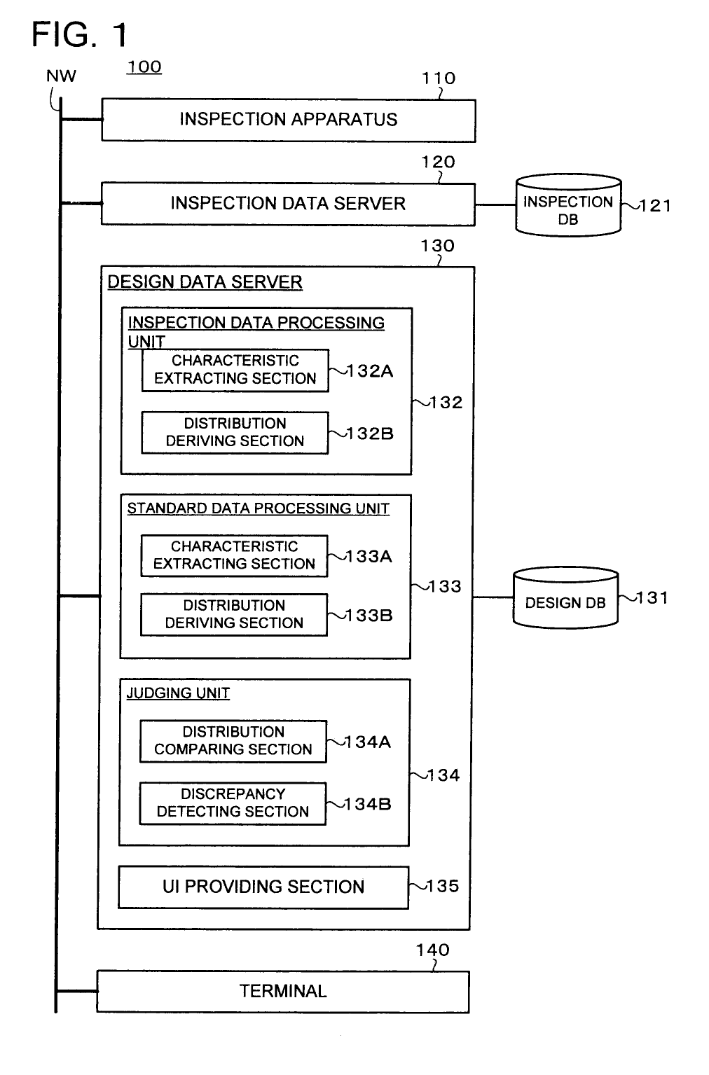

FIG. 1 is a block diagram showing an inspection system 100 according to an embodiment of the present invention. In the inspection system 100, a characteristic of design data in a defect place and a sample place of a semiconductor wafer is extracted and frequency distributions of the characteristic in the respective places are derived. Further, the frequency distributions of the characteristic in the defect places and the sample places are compared, and the characteristic with a large discrepancy of frequencies is detected. The inspection system 100 inspects a semiconductor manufacturing process step and has an inspection apparatus 110, an inspection data server 120, a design data server 130, a terminal 140, and a network NW.

The inspection apparatus 110 inspects a semiconductor device or a semiconductor wafer for manufacturing a semiconductor device.

The semiconductor wafer is used to manufacture a semiconductor device such as an IC (Integrated Circuit) and an LSI (Large Scale Integrated Circuit). Multiple processings are performed on a semiconductor wafer by a not-shown semiconductor manufacturing apparatus, whereby a semiconductor device is manufactured. For example, the following processings can be cited.

(1) Formation of a film: for example, by a CVD (Chemical Vapor Deposition) apparatus or a PVD (Physical Vapor Deposition) apparatus (vapor deposition apparatus, sputtering, etc.), a film of a metal, a semiconductor, an insulator or the like is formed on the semiconductor wafer.

(2) Formation of a resist: for example, by a spin coater, a layer of a resist for protecting the formed film from an etching material is formed on the semiconductor wafer.

(3) Exposure/development: for example, by a stepper, the resist is exposed and made to react. On this occasion, the resist is exposed to have a pattern by using a reticle (photomask). Thereafter, the exposed resist is developed by using a developing solution or the like, whereby the resist is patterned.

(4) Etching: By using the patterned resist as a mask (etching mask), the film is etched by the etching material (liquid, gas) and patterned. For example, a wiring is formed.

(5) Dicing: by using a dicing blade or the like, the semiconductor wafer is divided into a plurality of bits (semiconductor chips) (dicing). In many cases, a semiconductor device is formed in each of the plural semiconductor chips.

The semiconductor wafer (or semiconductor chip) having gone through such process steps has a plurality of patterned layers (for example, semiconductor layer, wiring layer, or the like). A pattern (reticle pattern) of the reticle (photomask) is determined so that a pattern (wafer pattern) of each layer of the semiconductor wafer coincides with a predetermined target pattern (a kind of processing pattern). Due to an optical proximity effect (OPE) at a time of exposure and side etching at a time of etching, the wafer pattern is different from the reticle pattern. In other words, the reticle pattern is determined in consideration of influences such as the optical proximity effect and the side etching. For example, an optical proximity correction is performed on the reticle pattern in consideration of the optical proximity effect.

The inspection apparatus 110 inspects the pattern in each layer of the semiconductor wafer, for example, by an optical technique. For example, an image of the semiconductor wafer is captured by an image capturing apparatus such as a CCD, an image-captured pattern (captured image) of each layer is compared with a predetermined reference pattern (reference image), and a place in which the both patterns do not coincide with each other is detected as a defect (failure). For example, a defect place can be detected by obtaining a difference (difference image) between the images by means of an image processing. It should be noted that the inspection apparatus 110 has stored the reference image. As the reference image, for example, the target pattern can be used.

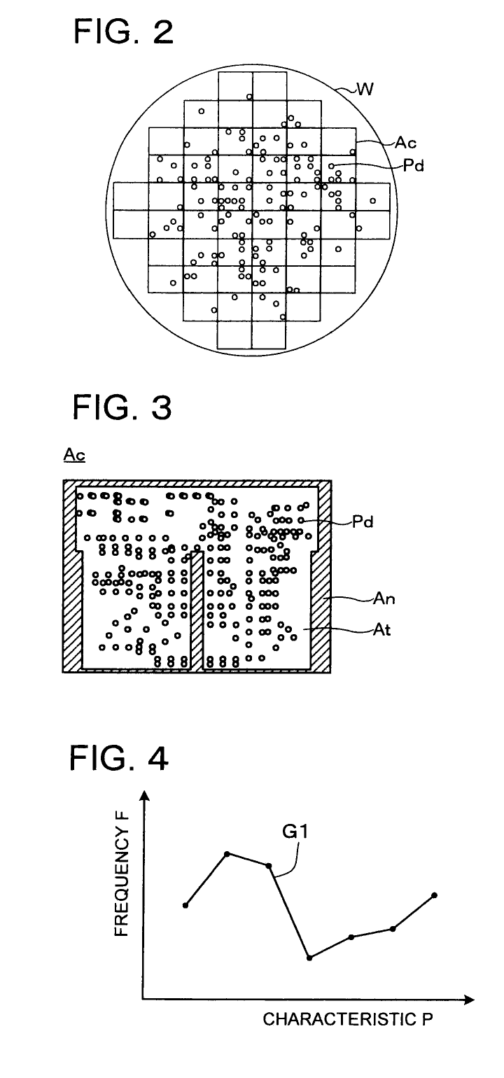

FIG. 2 is a diagram showing a correspondence between a semiconductor wafer W and a defect place Pd. The defect place Pd on the semiconductor wafer W is shown. The semiconductor wafer W is divided into areas (chip areas) Ac corresponding to the respective semiconductor chips C.

FIG. 3 is a diagram showing a correspondence between the semiconductor chip C (chip area Ac) and the defect place Pd. When getting an up-close look, the chip area Ac is divided into an area (inspection area At) to be a target of the inspection in the inspection apparatus 110 and an area (non-inspection are An) not to be the target of the inspection. In FIG. 3, hatching is performed on the non-inspection area An for the sake of comprehensibility. The defect place Pd is disposed only in the inspection area At. The non-inspection area An is an area in which an inspection of a defect is unnecessary because, for example, the area does not influence an operation of the semiconductor device. For example, since the semiconductor wafer W is cut into semiconductor chips C (dicing), a margin (cutting tab) for cutting is kept in a periphery of the chip area Ac. It should be noted that borders between the inspection area At and the non-inspection area An do not necessarily coincide in the respective layers of the semiconductor wafer W.

As shown in FIG. 3, the inspection apparatus 110 does not detect a defect in the non-inspection area An. For example, the difference image is calculated excluding the non-inspection area An. It is possible that the non-inspection area An is not eliminated in calculating the difference image but the non-inspection are An is eliminated in detecting the defect place. It should be noted that the inspection apparatus 110 has stored coordinates indicating a range of the inspection area At.

The inspection apparatus 110 calculates a position (coordinates) of the detected defect place Pd. For example, the position of the defect place Pd can be represented by two-dimensional coordinates (x, y) with a center of the semiconductor wafer W being an origin. Further, the inspection apparatus 110 calculates a size of the detected defect place Pd.

In order to inspect the pattern in each layer of the semiconductor wafer, sampling of the semiconductor wafer W in correspondence with etching in each layer of the semiconductor wafer is considered. For example, at every time of etching in each layer of the semiconductor wafer, one or a plurality of semiconductor wafer(s) is taken out from one lot and inspected in the inspection apparatus 110.

As described above, the inspection apparatus 110 has the reference image and information of the inspection area At with respect to each layer of the semiconductor wafer and compares the captured image and the reference image, thereby detecting a failure place (defect place) of the pattern and the size thereof for every layer.

The inspection data sever 120 is a server computer for holding an inspection result of the inspection apparatus 110. The inspection data server 120 accesses the inspection apparatus 110 via the network NW and holds the inspection result (information of the defect area Pd) in the inspection database (DB) 121.

The inspection DB 121 is a memory device such as a hard disc, and is disposed inside or outside the inspection data server 120. The inspection DB 121 holds, for example, information of the defect place Pd and the inspection area At. The information of the defect place Pd includes the number, the coordinates, and the size of the defect place. The information of the inspection area At is coordinates indicating the range of the inspection area At to be the target of the inspection.

The design data server 130 is a server computer to process design data for manufacturing a semiconductor device, and has a design data base (DB) 131, an inspection data processing unit 132, a standard data processing unit 133, a judging unit 134, and a user interface (UI) providing section 135. The design data server 130 functions as a defect analyzing apparatus.

The design DB 131 is a storage device such as a hard disc, and is disposed inside or outside the design data server 130. The design DB 131 holds design data, and functions as a storage section storing data including information of a processing pattern corresponding to a predetermined processing to the semiconductor wafer.

The design data is data for pattern designing of each layer of the semiconductor wafer, and includes information of the target pattern (a kind of processing pattern) to be the target of patterning of the semiconductor wafer. As already described, the reticle pattern is determined so that the wafer pattern coincides with this processing pattern.

As will be described later, it is possible to extract a characteristic in each pair of coordinates on the semiconductor wafer from the design data. This characteristic means a characteristic of the pattern in a neighborhood of that pair of coordinates and can be classified into a characteristic amount and a characteristic figure. The characteristic amount is a quantitative characteristic of the pattern, and is, for example, a minimum line width, a maximum line width, a minimum space width, a maximum space width, a covering rate, a circumference length, a vertex number, or a directionality.

The minimum line width and the maximum line width are a minimum value and a maximum value of widths of remaining portions, respectively.

The minimum space width and the maximum space width are a minimum value and a maximum value of widths of opening portions, respectively.

The covering rate R is a ratio of an area the remaining portion occupies (R=S1/(S0+S1), S1: area of remaining portion, S0: area of opening portion).

The circumference length is a total of lengths of the borders of the pattern.

The vertex number is the number of vertexes of the pattern.

The directionality is a direction of the pattern (boarder), for example, a vertical direction or a lateral direction.

The characteristic figure is a characteristic in terms of a figure (shape) of a pattern, and means that a shape (pattern shape) of the opening portion (etched area) or the remaining portion (area left not etched) is classified into which one of, for example, rectangular, arc-shaped, linear, and T-shaped.

The inspection data processing unit 132 processes the inspection data and derives the frequency distribution of the characteristic of the design data in the defect places Pd, and has a characteristic extracting section 132A and a distribution deriving section 132B.

The characteristic extracting section 132A extracts the characteristic of the design data in a neighborhood of each defect place (coordinates at which a defect is detected) of the semiconductor wafer. For example, the characteristic of the design data in a predetermined area (characteristic extracting area) centering on the coordinates of the defect place is extracted. As described above, the characteristic of the design data includes the characteristic amount and the characteristic figure. The characteristic extracting section 132A functions as a second extracting section extracting a second frequency distribution of each of the characteristics in a plurality of defect places in the semiconductor chip.

The distribution deriving section 132B derives a frequency distribution (frequency distribution of a characteristic in defect places Pd (inspection target frequency distribution)) of the characteristic extracted in the characteristic extracting section 132A. FIG. 4 is a graph showing an example of the frequency distribution of the characteristic derived by the distribution deriving section 132B. A frequency F of the characteristic is shown in correspondence with a characteristic P. For example, a frequency of appearance of defect places for the minimum line width is shown. The distribution deriving section 132B functions as a second deriving section deriving a second correspondence between a characteristic and a frequency.

The standard data processing unit 133 derives the frequency distribution of the characteristic of the design data in the sample places Ps, and has a characteristic extracting section 133A and a distribution deriving section 133B.

The characteristic extracting section 133A determines a sample place (coordinates to be a sample) in the inspection area At of the semiconductor wafer and extracts the characteristic of the design data in a neighborhood of each sample place. For example, the characteristic of the design data in a predetermined area (characteristic extracting area) centering on the coordinates of the sample place is extracted. The characteristic extracting section 133A functions as a first extracting section extracting a characteristic of a processing pattern in each of a plurality of sample places.

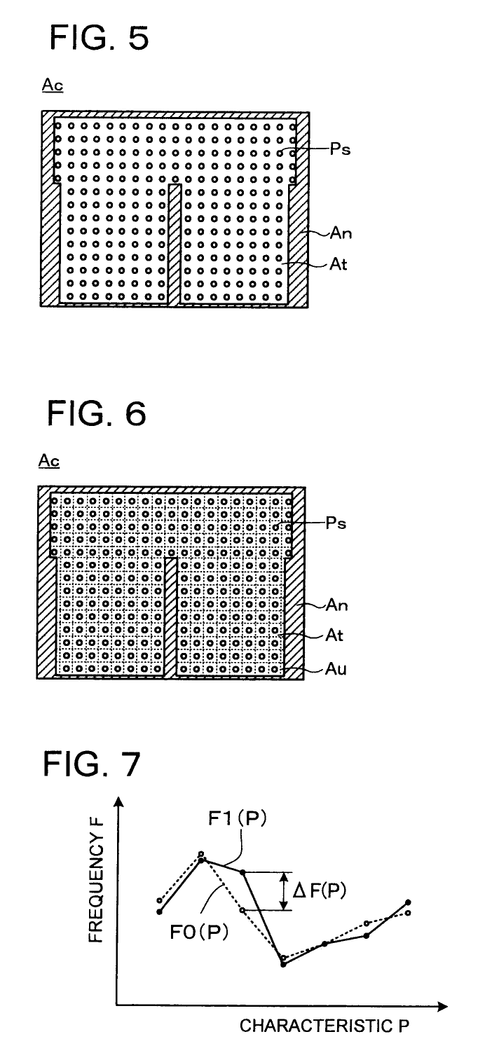

FIG. 5 is a diagram showing an example of a relation between the semiconductor chip C and the sample place Ps. The sample places Ps are disposed almost at even intervals vertically and horizontally in the inspection area At.

Here, the inspection area At is divided accordingly by every semiconductor chip (for example, divided into areas of 100×100) and sample places Ps can be set in correspondence with these divided areas (unit areas). FIG. 6 is a diagram showing an example of a relation between the unit area Au and the sample place Ps on the semiconductor chip C. The sample place Ps is allotted to each unit area Au. It should be noted that the disposition of the sample place Ps itself is the same as that in FIG. 5.

As described above, when the inspection area At is divided into unit areas Au, the sample place Ps can be selected in relation to the unit area Au. For example, (1) the sample places Ps are allotted to all the unit areas Au (total pattern search) or (2) the sample place Ps is accordingly selected from the unit areas Au (spatial sampling). In a case of the spatial sampling, there exists a unit area Au to which a sample place Ps is not allotted. For selection of the above, either of selection at random and selection with a predetermined interval (periodical selection) can be adopted.

Here, it is possible to select the sample places Ps by using the inspection data. For example, the number or coordinates of the sample places Ps is determined by using the inspection data. The sample places Ps can be selected so that the number of the sample places Ps becomes not less than (equal to or larger than) the number of the defect places Ps. Further, the sample places Ps can be selected so that an area with high frequency of appearance of the defect places Pd is eliminated.

The distribution deriving section 133B derives a frequency distribution (frequency distribution of a characteristic in sample places (standard frequency distribution)) of the characteristic extracted in the characteristic extracting section 133A. If there is knowledge of an appearance probability of the characteristic, the standard frequency distribution can be generated by using the appearance probability of the characteristic. The distribution deriving section 133B functions as a first extracting section extracting a first frequency distribution of each of characteristics in a plurality of sample places in a semiconductor chip.

The judging unit 134 judges abnormality of the design data, and has a distribution comparing section 134A and a discrepancy detecting section 134B.

The distribution comparing section 134A compares the frequency distributions (frequency distributions in the defect places and the sample places) of the characteristic derived in the respective distribution deriving sections 132B, 133B.

The discrepancy detecting section 134B detects the characteristic having a large difference (having a discrepancy) in frequencies in the compared frequency distributions. The discrepancy detecting section 134B B functions as a detecting section detecting discrepancies between the first and second frequencies.

The discrepancy detecting section 134B detects, for example, the characteristic where an absolute value of a difference in values of frequencies is larger than a predetermined threshold value. FIG. 7 is a graph for explaining detection of the characteristic in the discrepancy detecting section 134B. A frequency distribution F1 (P) in the defect places and a frequency distribution F0 (P) in the sample places are shown as a graph. A characteristic P (for example, a value of the minimum line width) where a difference (ΔF(P)=F1(P) −F0(P)) between the frequency distributions F1(P) and F0(P) is larger than the threshold value is detected. The discrepancy detecting section 134B may detect a characteristic by using a statistical method (for example, chi-square test) instead of by using the absolute value of a difference in values of frequencies. In this case, the characteristic has a statistical significant difference between the frequency distributions.

It is considered that the characteristic detected on this occasion is a cause of defect occurrence. That is, the characteristic of the design data is related to the defect. As described above, the defect which can be related to the characteristic of the design data is what is called a systematic defect. The systematic defect is a defect occurring in correspondence with the design data. For example, a systematic defect occurs in relation to the optical proximity effect, side etching or the like, due to lack of a margin in designing. Incidentally, a defect occurring irrelevantly to the design data by, for example, accidental interfusion of a foreign object (particle or the like) is called a random defect.

The detection of the characteristic (discrepancy characteristic) with the large discrepancy between the defect place Pd and the sample place Ps described above can be performed for every characteristic type. The discrepancy characteristic can be extracted, for example, for each of the minimum line width, the maximum line width, the minimum space width, the maximum space width, the covering rate, the circumference length, the vertex number, the directionality, and the shape of the pattern.

The UI providing section 135 provides a user interface such as displaying an operation menu on a screen of the terminal 140.

The terminal 140 is a computer terminal for operating the inspection apparatus 110, the inspection data server 120, and the design data server 130.

The network NW connects the inspection apparatus 110, the inspection data server 120, the design data server 130, and the terminal 140, thereby enabling communication.

### (Operation of Inspection System 100)

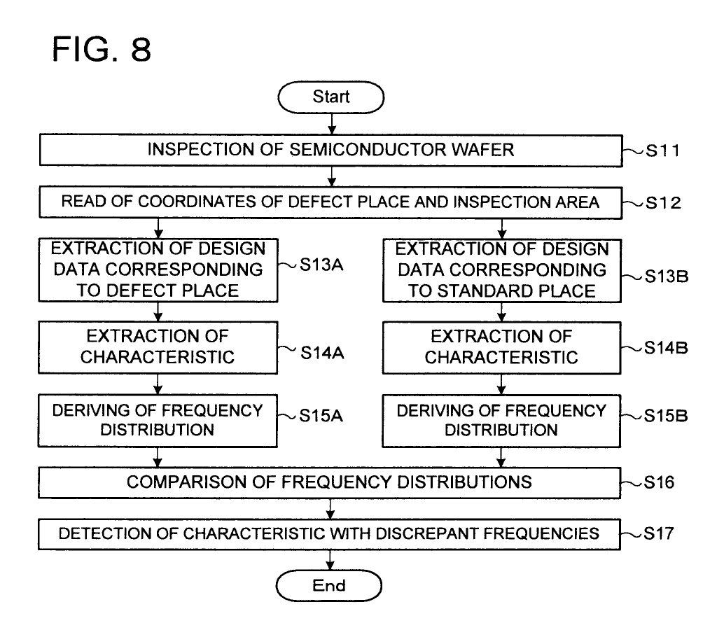

An operation of the inspection system 100 will be described. FIG. 8 is a flowchart showing an example of operational procedures of the inspection system 100.

(1) Inspection of Semiconductor Wafer (Step S11)

The inspection apparatus 110 inspects a semiconductor wafer. The inspection apparatus 110 compares a pattern (wafer pattern) in each layer of the semiconductor wafer with a processing pattern, to detect a defect of the pattern on the semiconductor wafer. Further, coordinates and a size of the defect are specified and took as inspection data. The inspection data (defect coordinates, defect size) is transmitted from the inspection apparatus 110 to the inspection data server 120 and held in the inspection DB 121.

(2) Read of Coordinates of Defect Place (Step S12)

The design data server 130 reads the coordinates of the defect place and an inspection area from the inspection data server 120.

(3) Deriving of Frequency Distribution of Characteristic in Defect Place (Step S13A to Step S15A)

A frequency distribution of a characteristic in the defect places is derived. More specifically, the frequency distribution can be derived by the following procedures. The characteristic extracting section 132A pull design data (design data in a neighborhood of the defect coordinates) corresponding to the defect place from the design DB 131. The characteristic extracting section 132A extracts a characteristic (for example, minimum line width) by predetermined types, based on the whole or part of the pulled design data. The distribution deriving section 132B derives the frequency distribution of the characteristic according the predetermined types.

(4) Deriving of Frequency Distribution of Characteristic in Sample Place (Step S13 to Step S15B)

A frequency distribution of the characteristic in sample places is derived. More specifically, the frequency distribution can be derived by the following procedures. The characteristic extracting section 133A selects coordinates of the sample place from an inspection target area. The characteristic extracting section 133A pulls design data (design data in a neighborhood of the sample coordinates) corresponding to the sample place from the design DB 131. The characteristic extracting section 133A pulls the characteristic (for example, minimum line width) according to the predetermined types, based on the whole or part of the pulled design data. The distribution deriving section 132B derives the frequency distribution of the characteristic according to the predetermined types.

For the frequency in the defect places or the sample places, the number of the defect places or the sample places corresponding to the character can be used. When the numbers of the defect places and the sample places are different, normalization of the both enables comparison of the distributions with different parameters.

When analyzing defects of a plurality of semiconductor wafers W successively, by storing the frequency distribution of the characteristic in the sample places after the frequency distribution of the characteristic in the sample places is derived, another deriving can be made unnecessary.

(5) Comparison of Frequency Distributions, Detection of Characteristic with Discrepancy in Frequencies (Step S16, Step S17)

The frequency distributions in the defect places and the sample places are compared and the characteristic having a discrepancy is detected. The characteristic where the defect is more likely to occur and largeness of the discrepancy at that time can be detected. The detected characteristic or the like is transmitted to the terminal 140.

As a result, it becomes possible to judge to which characteristic in the design data the defect of the semiconductor wafer W relates as well as largeness of relativity. By the largeness of relativity, it becomes possible to judge a design margin in a process condition under which the defect inspection of the related characteristic has been performed.

When the characteristic having a discrepancy is extracted, a measure such as feedback to each process step can be taken. Further, by judging the margin of the design in the process condition under which the defect inspection has been performed, feedback to each process step or to designing becomes possible.

As described above, in a manufacturing process of the semiconductor device, abnormality in a process step is detected quickly and information is transmitted quickly to each process step, whereby it becomes possible to minimize a yield loss. Further, a characteristic (discrepancy characteristic) where abnormality occurs is detected by using design data, whereby a steep start-up of anew process becomes possible. Further, since it becomes possible to calculate a design margin in a certain process condition, designing in consideration of manufacturing easiness becomes possible.

### Other Embodiment

The embodiment of the present invention is not limited to the above-described embodiment and can be expanded and modified, and the expanded and modified embodiments are also included in the technical range of the present invention. For example, it may found that yields in a plurality of wafers to be the target of the inspection are smaller than yields in standard wafers. In this case, if a plurality of discrepancy portions (discrepancy characteristics) where characteristic amounts are different each other than a threshold value are detected in the plurality of wafers to be the target of the inspection, the discrepancy portion having a large influence can be judged by using a statistical method (for example, analysis of variance) and a model of an influence to yields can be made.

In the above embodiment, the defect at the time of etching of the semiconductor wafer is taken as a problem (etching is treated as a processing step). Thus, the processing pattern is used as the target pattern. Here, it is possible to select various types of processing patterns depending on a processing step to be taken as a problem and a way of analyzing the problem.

For example, if impurity doping to a semiconductor wafer is taken as a problem, it is preferable to use a doping pattern (pattern indicating a target of distribution of impurities on the semiconductor wafer) as a processing pattern. Thereby, analysis of a systematic defect due to doping becomes possible.

If exposure to the semiconductor wafer is taken as a problem, by using a pattern for a photomask having been subjected to optical proximity correction (OPC) as a processing pattern, analysis of a systematic defect due to adequacy of the optical proximity correction becomes possible. Further, by using a pattern of the photomask itself as a processing pattern, analysis of a systematic defect due to adequacy of exposure by the photomask becomes possible.

In the above embodiment, an object that the reference pattern in the inspection apparatus 110 represents and an object that the processing pattern in the characteristic extracting section 132A represents coincide with each other (each pattern represent an etching state of the semiconductor wafer). In such a case, soon after a predetermined processing (here, etching) to the semiconductor wafer, the etching state is inspected to detect a defect place Pd, and a characteristic of the target pattern of etching in the defect place Pd is extracted. As a result, a direct correspondence between the predetermined processing (here, etching) and occurrence of the defect is derived.

On the other hand, it is also possible to use a processing pattern different from an inspection content in the inspection apparatus 110. In other words, it is possible that a reference pattern in the inspection apparatus 110 and a processing pattern in the characteristic extracting section 132A represent different things from each other. In such a case, there is a high possibility that timings of a predetermined processing (corresponding to the processing pattern) and inspection (corresponding to the reference pattern) do not coincide with each other. In other words, a characteristic is extracted by using a processing corresponding, not to a processing just before the inspection, but to a processing still before the inspection or a processing after the inspection.

As an example of using the processing pattern corresponding to the processing before the processing just before the inspection, the following can be cited. That is, it is a case that inspection soon after a predetermined processing is difficult and analysis of a systematic defect due to that processing is necessary. In such a case, an indirect correspondence between the predetermined processing and occurrence of the defect is derived.

As an example of using the processing pattern corresponding to a predetermined processing after the inspection, the following can be cited. That is, it is a case that the processing pattern corresponding to a processing step after the inspection is used in order to analyze an influence to the processing step thereafter.

As described above, various processing patterns can be selected. It suffices if the processing pattern is something (pattern) to represent spatial disposition (coordinates) of materials or the like on a semiconductor wafer, and it is possible to use design data in general.

What is claimed is:

1. A defect analyzing apparatus, comprising:
a storage section storing data including information of a processing pattern corresponding to a predetermined processing to a semiconductor wafer;
a first extracting section extracting a first frequency distribution of each of characteristics in a plurality of sample places in a semiconductor chip;
a second extracting section extracting a second frequency distribution of each of the characteristics in a plurality of defect places in the semiconductor chip; and
a detecting section detecting discrepancies between the first and second frequencies.

2. The defect analyzing apparatus as set forth in claim 1,
wherein the characteristics include a minimum line width, a maximum line width, a minimum space width, a maximum space width, a covering rate, a circumference length, a vertex number, a directionality, or a pattern shape.

3. The defect analyzing apparatus as set forth in claim 1,
wherein the number of the plurality of sample places is equal to or larger than the number of the plurality of defect places.

4. The defect analyzing apparatus as set forth in claim 1, further comprising:
selecting the plurality of sample places so that the plurality of sample places correspond to any ones of the plurality of unit areas set on the semiconductor chip.

5. The defect analyzing apparatus as set forth in claim 1,
wherein the number of the plurality of sample places is equal to or more than the number of the plurality of defect places.

6. The defect analyzing apparatus as set forth in claim 1, wherein the number of the plurality of sample places is equal to the number of the plurality of unit areas.

7. The defect analyzing apparatus as set forth in claim 1,
wherein the number of the plurality of sample places is smaller than the number of the plurality of unit areas and the plurality of sample places are selected at random or regularly.

8. The defect analyzing apparatus as set forth in claim 1,
wherein the first and the second correspondences represent frequency distributions of the characteristic.

9. The defect analyzing apparatus as set forth in claim 1,
wherein the semiconductor chip is divided into the plurality of unit areas.

10. A defect analyzing method, comprising:
extracting a first frequency distribution of each of characteristics in a plurality of sample places in a semiconductor chip;
extracting a second frequency distribution of each of the characteristics in a plurality of defect places in the semiconductor chip; and
detecting discrepancies between the first and second frequencies.

11. The defect analyzing method as set forth in claim 10,
wherein the characteristics include a minimum line width, a maximum line width, a minimum space width, a maximum space width, a covering rate, a circumference length, a vertex number, a directionality, or a pattern shape.

12. The defect analyzing method as set forth in claim 10,
wherein the number of the plurality of sample places is equal to or larger than the number of the plurality of defect places.

13. The defect analyzing method as set forth in claim 10, further comprising
selecting the plurality of sample places so that the plurality of sample places correspond to any ones of the plurality of unit areas set on the semiconductor chip.

14. The defect analyzing method as set forth in claim 13,
wherein the number of the plurality of sample places is equal to the number of the plurality of unit areas.

15. The defect analyzing method as set forth in claim 13,
wherein the number of the plurality of sample places is smaller than the number of the plurality of unit areas and the plurality of sample places are selected at random or regularly.

16. The defect analyzing method as set forth in claim 13,
wherein the semiconductor chip is divided into the plurality of unit areas.
